(19) United States
(12) Patent Application Publication
(10) Pub. No.: US 2025/0263069 A1
(43) Pub. Date: Aug. 21, 2025

(54) Apparatus for Rear Cross-Traffic Collision-Avoidance Assist and Operating Method Therefor

(71) Applicants: Hyundai Motor Company, Seoul (KR); Kia Corporation, Seoul (KR)

(72) Inventors: Young Won Heo, Hwaseong-si (KR); Seung Hwan Kim, Siheung-si (KR); Dae Hoon Park, Seoul (KR); Yu Rim Park, Busan (KR)

(21) Appl. No.: 18/985,429

(22) Filed: Dec. 18, 2024

(30) Foreign Application Priority Data
Feb. 16, 2024 (KR) 10-2024-0022406

(51) Int. Cl. B60W 30/06; G08G 1/16

(52) U.S. Cl. CPC B60W 30/06; G08G 1/168

(57) ABSTRACT

A rear cross-traffic collision-avoidance assist apparatus and a method of operating the same are provided. An apparatus may include: at least one sensor; memory storing instructions; and at least one processor. The at least one processor may be configured to, by executing the instructions, cause the apparatus to: obtain, via the at least one sensor, one or more images of a parking area associated with a vehicle; determine, based on the one or more images, a type of a parking space in the parking area; adjust, within the parking area, an area of interest by adjusting, based on the type of the parking space, at least one of a size of the area of interest or an angle of the area of interest; and control, based on the adjusted area of interest, an operation of the vehicle.

### CROSS-REFERENCE TO RELATED APPLICATION

This application claims the benefit of Korean Patent Application No. 10-2024-0022406, filed on Feb. 16, 2024, the content of which is incorporated herein by reference.

### TECHNICAL FIELD

The present disclosure relates to a rear cross-traffic collision-avoidance assist apparatus and a method of operating the same.

### BACKGROUND

The content described below simply provides background information related to the present disclosure and does not constitute prior art.

When a vehicle reverses, the driver watches the rear of the vehicle using side-view mirrors and a rearview mirror. However, the side-view mirrors and rearview mirror may offer only a limited field of view. To overcome such a problem, a system such as a surround view monitor is sometimes installed in vehicles.

### SUMMARY

An object of the present disclosure is to provide an RCCA that optimizes a warning area according to the type of parking space.

The object to be achieved by the present disclosure is not limited to the object mentioned above, and other objects that are not mentioned will be clearly understood by those skilled in the art from the description below.

According to one or more example embodiments of the present disclosure, an apparatus may include: at least one sensor; memory storing instructions; and at least one processor. The at least one processor may be configured to, by executing the instructions, cause the apparatus to: obtain, via the at least one sensor, one or more images of a parking area associated with a vehicle; determine, based on the one or more images, a type of a parking space in the parking area; adjust, within the parking area, an area of interest by adjusting, based on the type of the parking space, at least one of a size of the area of interest or an angle of the area of interest; and control, based on the adjusted area of interest, an operation of the vehicle.

The type of the parking space may include at least one of a parking space for perpendicular parking or a parking space for diagonal parking.

The at least one processor may be configured to cause the apparatus to adjust the area of interest by: adjusting, based on the type of the parking space being a parking space for perpendicular parking, a longitudinal distance of the area of interest from the vehicle to be less than a default value.

The at least one processor may be configured to cause the apparatus to adjust the area of interest by: determining, based on the type of the parking space being a parking space for diagonal parking, a diagonal parking angle.

The at least one processor may be configured to cause the apparatus to adjust the area of interest further by: changing, based on the diagonal parking angle, at least one of the size of the area of interest or the angle of the area of interest.

The at least one processor may be configured to cause the apparatus to adjust the area of interest further by: determining a vehicle coordinate system having axes respectively corresponding to longitudinal and lateral directions of the vehicle; determining, based on the diagonal parking angle, a plurality of reference points in the vehicle coordinate system; and adjusting, based on a line connecting the plurality of reference points, the area of interest.

The at least one processor may be configured to cause the apparatus to control the operation of the vehicle by: determining whether an object is present within the area of interest.

The at least one processor may be configured to cause the apparatus to control the operation of the vehicle by: generating, based on the object being present within the area of interest, a warning message.

The at least one processor may be configured to cause the apparatus to adjust the area of interest by: determining, based on the type of the parking space not being a parking space for perpendicular parking or a parking space for diagonal parking, the area of interest according to a default value.

According to one or more example embodiments of the present disclosure, a method performed by a vehicle may include: obtaining, via at least one sensor, one or more images of a parking area associated with the vehicle; determining, based on the one or more images, a type of a parking space in the parking area; adjusting, within the parking area, an area of interest by adjusting, based on the type of the parking space, at least one of a size of the area of interest or an angle of the area of interest; and controlling, based on the adjusted area of interest, an operation of the vehicle.

The type of the parking space may include at least one of a parking space for perpendicular parking or a parking space for diagonal parking.

Adjusting the area of interest may include: adjusting, based on the type of the parking space being a parking space for perpendicular parking, a longitudinal distance of the area of interest from the vehicle to be less than a default value.

Adjusting the area of interest may include: determining, based on the type of the parking space being a parking space for diagonal parking, a diagonal parking angle.

Adjusting the area of interest may include: changing, based on the diagonal parking angle, at least one of the size of the area of interest or the angle of the area of interest.

Adjusting the area of interest may include: determining a vehicle coordinate system having axes respectively corresponding to longitudinal and lateral directions of the vehicle; determining, based on the diagonal parking angle, a plurality of reference points in the vehicle coordinate system; and adjusting, based on a line connecting the plurality of reference points, the area of interest.

Controlling the operation of the vehicle may include: determining whether an object is present within the area of interest.

Controlling the operation of the vehicle may include: generating, based on the object being present within the area of interest, a warning message.

Adjusting the area of interest may include: determining, based on the type of the parking space not being a parking space for perpendicular parking or a parking space for diagonal parking, the area of interest according to a default value.

The effects of the present disclosure are not limited to the effects mentioned above, and other effects that are not mentioned may be clearly understood by those skilled in the art from the description below.

### BRIEF DESCRIPTION OF THE DRAWINGS

FIG. 1 is a block diagram schematically showing a rear cross-traffic collision-avoidance assist apparatus.

FIG. 2 is a diagram showing default values of a parking space and a warning area.

FIG. 3A is a diagram illustrating an exemplary warning area in case of perpendicular parking.

FIG. 3B is a diagram illustrating an exemplary warning area in case of diagonal parking.

FIG. 4 is a flowchart showing a method for setting a warning area.

### DETAILED DESCRIPTION

Hereinafter, one or more example embodiments of the present disclosure will be described in detail with reference to the accompanying drawings. In the following description, like reference numerals preferably designate like elements, although the elements are shown in different drawings. Further, in the following description of example embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

The rear cross-traffic collision-avoidance assist (RCCA) system may be installed in vehicles to prevent accidents during reversing. RCCA is a system that detects vehicles approaching from the rear and sides of a vehicle using a radar sensor or the like and provides a warning to the driver using sound (e.g., an audible signal) when an approaching vehicle is detected. RCCA has a warning area at a set distance from the rear of the vehicle. The warning area may be an area for issuing a warning when there is a vehicle moving in the area. When a vehicle is parked diagonally, a radar detection area may need to be expanded to detect vehicles approaching in a rear lateral direction. In other words, if the radar detection area of RCCA is too narrow, it may be difficult to prevent a collision. If, on the other hand, the radar detection area is too wide, unnecessary warnings may be issued even when the risk of collision is relatively low, thus possibly eroding the driver's trust in the RCCA. Therefore, the radar detection area of RCCA may need to be optimized according to the type of parking space.

The following detailed description, together with the accompanying drawings, is intended to describe example embodiments of the present disclosure, and is not intended to represent the only embodiments in which the present disclosure may be practiced.

Singular terms which will be used below may include plural terms unless otherwise specified.

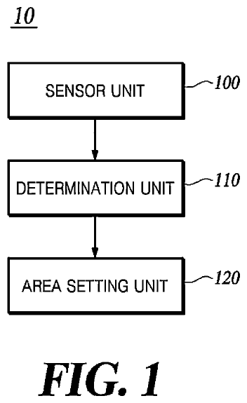

FIG. 1 is a block diagram schematically showing a rear cross-traffic collision-avoidance assist apparatus.

Referring to FIG. 1, a rear cross-traffic collision-avoidance assist apparatus 10 includes some or all of a sensor unit 100, a determination unit 110, and an area setting unit 120.

The sensor unit 100 detects objects such as other vehicles, bicycles, motorcycles, and people behind a subject vehicle. The sensor unit 100 may include at least one of a radar, lidar, and camera. The sensor unit 100 may measure a movement direction, path, speed, and acceleration of an object located behind the subject vehicle, a distance between the object and the subject vehicle, and the like.

The sensor unit 100 detects objects moving within a warning area set by the area setting unit 120, such as vehicles, motorcycles, bicycles, and pedestrians. If a moving object is present within the warning area, the sensor unit 100 generates a warning message indicating presence of the object within the warning area.

The sensor unit 100 obtains a surrounding image of the vehicle. Here, the surrounding image of the vehicle is an image including parking lines. The sensor unit 100 may obtain surrounding images of the vehicle using at least one camera. The surrounding images of the vehicle may include images of the front, rear, right side, and left side of the vehicle. That is, the sensor unit 100 obtains images including parking lines in the front, rear, right, and left sides of the vehicle. For example, the surrounding image of the vehicle may be an image that combines images obtained from a front camera, a rear camera, a left-side camera, and a right-side camera.

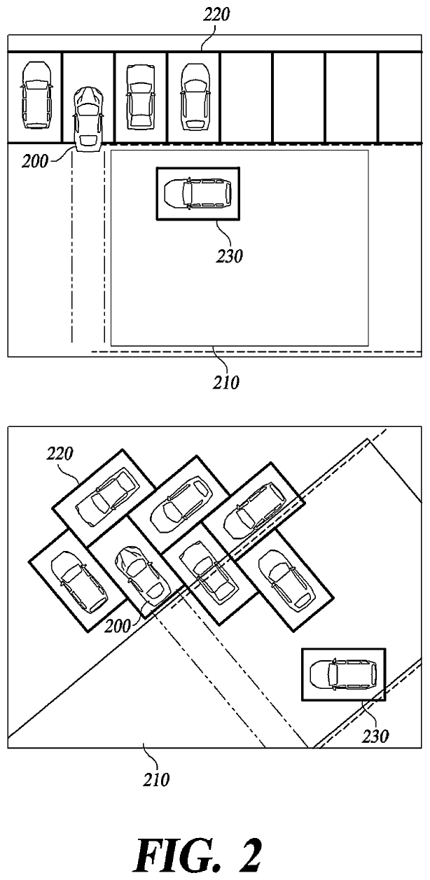

FIG. 2 is a diagram showing default values of a parking space and a warning area.

Referring to FIG. 2, FIG. 2A is a diagram illustrating a perpendicular parking situation. FIG. 2B is a diagram illustrating a diagonal parking situation.

The determination unit 110 determines the type of a parking space 220 where the subject vehicle 200 is parked. Here, the type of parking space 220 includes perpendicular parking and diagonal parking. The parking space 220 refers to a space for one vehicle to park. The parking space 220 may include a plurality of parking lines. For example, the parking space 220 may include four parking lines or three parking lines.

The shape of the parking space 220 may be quadrilateral. For example, the shape of the parking space 220 may be a rectangle. As another example, the shape of the parking space 220 may be a parallelogram. Alternatively, the shape of the parking space 220 may be polygonal.

The determination unit 110 may determine the type of the parking space 220 using an image obtained by the sensor unit 100. To determine parking lines, the determination unit 110 may include a pre-trained artificial intelligence model. The pre-trained artificial intelligence model is an artificial intelligence model trained to determine the type of the parking space 220 upon receiving an image including parking lines. The pre-trained artificial intelligence model may receive a surrounding image of the vehicle, obtained by the sensor unit 100, and determine the type of the parking space 220 where the subject vehicle is parked. The determination unit 110 determines whether the type of the parking space 220 is perpendicular parking or diagonal parking using the pre-trained artificial intelligence model.

When the type of the parking space 220 is diagonal parking, the determination unit 110 calculates the diagonal parking angle (e.g., a parking direction). The diagonal parking angle is calculated using the image obtained by the sensor unit 100. The determination unit 110 generates a virtual straight line connecting vertices that do not contact other parking spaces 220 among a plurality of vertices of the parking space 220. The determination unit 110 calculates the angle between the virtual straight line and the center line of the vehicle. Here, the center line of the vehicle is a line passing through the front of the vehicle, the rear of the vehicle, and the center of the vehicle. The determination unit 110 determines the angle between the virtual straight line and the center line of the vehicle as the diagonal parking angle.

In other words, the determination unit 110 can determine the type of the parking space 220 and the diagonal parking angle. The determination unit 110 transmits the type of the parking space 220 and the diagonal parking angle to the area setting unit 120.

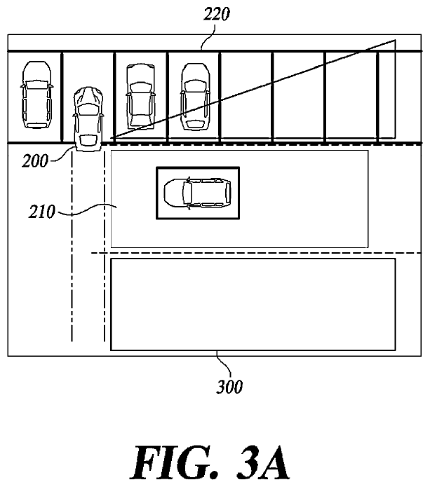

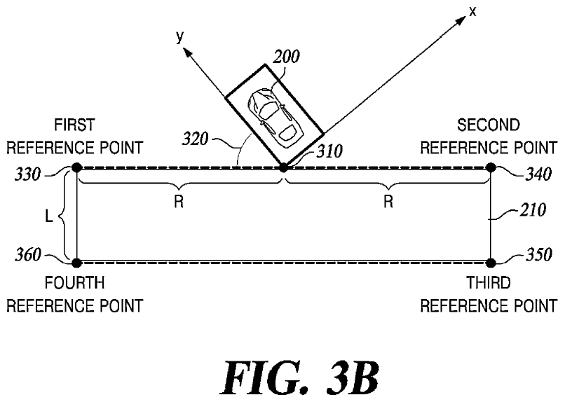

The area setting unit 120 sets a warning area (also referred to as an area of interest) 210 on the basis of the type of the parking space 220 and the diagonal parking angle determined by the determination unit 110. The warning area 210 is an area in which a warning needs to be issued when objects 230 such as vehicles, bicycles, motorcycles, and people are present in the area. Hereinafter, setting of the warning area 210 will be described with reference to FIGS. 3A and 3B.

FIG. 3A is a diagram illustrating an exemplary warning area in case of perpendicular parking.

Referring to FIG. 3A, the warning area 210 includes an area within a certain vertical distance from the subject vehicle 200. For example, the warning area 210 may include an area where the vertical distance from the subject vehicle 200 (e.g., the longitudinal distance relative to the subject vehicle 200) is within 3 m. Here, the vertical distance is the distance from the center point of the rear bumper of the subject vehicle 200 in a direction perpendicular to the rear bumper.

If the type of the parking space 220 is perpendicular parking, if the warning area 210 is excessively wide, a warning sound may be issued too frequently even when the possibility of collision is relatively low. Additionally, since the RCCA function can include a braking function, repeated stops may cause user inconvenience. That is, if the type of the parking space 220 is perpendicular parking, the warning area 210 needs to be narrowed (e.g., the warning area 210 may be adjusted to reduce the size of the warning area 210). If the type of the parking space 220 is perpendicular parking, the area setting unit 120 may reduce the warning area by removing a part 300 of the warning area 300 from the warning area 210 to set a new warning area 210. For example, the area setting unit 120 may set an area within the longitudinal distance of 3 m from the vehicle as the warning area 210.

FIG. 3B is a diagram illustrating an exemplary warning area in case of diagonal parking.

Referring to FIG. 3B, the area setting unit 120 receives a diagonal parking angle 320 from the determination unit 110. The area setting unit 120 sets the warning area 210 using the diagonal parking angle 320.

The area setting unit 120 sets reference points 330, 340, 350, and 360 of the warning area 210 using a coordinate system in order to set the warning area 210. The area setting unit 120 may set an area within a straight line connecting the reference points as the warning area 210.

If parking is not perpendicular or diagonal, the warning area 210 may include an area within 6 m from the vehicle. That is, the default value of the warning area 210 may be an area within 6 m from the rear of the vehicle.

Hereinafter, a detailed process in which the area setting unit 120 sets the warning area 210 using the diagonal parking angle 320 will be described.

The area setting unit 120 sets the end of the rear bumper of the subject vehicle 200 as the origin 310. Here, the end of the rear bumper of the subject vehicle 200 indicates the rightmost side or the leftmost side of the rear bumper of the subject vehicle 200. The area setting unit 120 sets the origin 310 on the basis of the direction in which the subject vehicle 200 is parked. For example, when the parked subject vehicle 200 faces to the right based on the front of the vehicle, the rightmost side of the rear bumper of the vehicle is set as the origin 310. On the other hand, when the parked vehicle faces to the left, the leftmost side of the rear bumper of the vehicle is set as the origin 310.

The area setting unit 120 sets a vehicle coordinate system. The vehicle coordinate system is a coordinate system having the longitudinal direction of the subject vehicle and the lateral direction of the subject vehicle as axes. The origin of the vehicle coordinate system is the origin 310 set by the area setting unit 120. The vehicle coordinate system may be, for example, a polar coordinate system.

The area setting unit 120 sets the reference points 330, 340, 350, and 360 of the warning area 210. The area setting unit 120 may set the reference points 330, 340, 350, and 360 on the vehicle coordinate system. Some of the reference points 330, 340, 350, and 360 may be set using the distance from the origin 310 and the diagonal parking angle 320. Some of the reference points 330, 340, 350, and 360 may be separated from the origin 310 by a certain predefined distance R. For example, some of the reference points 330, 340, 350, and 360 may be 20 m away from the origin 310.

The positions of the reference points 330, 340, 350, and 360 are set on the basis of the diagonal parking angle 320. Some of the reference points 330, 340, 350, and 360 may be located on a virtual line parallel to a virtual straight line for determining the diagonal parking angle 320. For example, when the diagonal parking angle 320 is θ, some of the reference points 330, 340, 350, and 360 have angles of θ−0.5π and 0.5π+θ from the transverse axis of the subject vehicle.

The area setting unit 120 may set four reference points 330, 340, 350, and 360. The first reference point 330 is located in the upper left corner. The second reference point 340 to the fourth reference point 360 are located clockwise from the first reference point 330.

The straight line connecting the first reference point 330 and the second reference point 340 is parallel to the virtual straight line for determining the diagonal parking angle 320. The straight line connecting the third reference point 350 and the fourth reference point 360 is parallel to the straight line connecting the first reference point 330 and the second reference point 340.

The third reference point 350 may be located away from the second reference point 340 by a predefined distance L. The fourth reference point 360 may be located away from the first reference point 330 by a predefined distance L. For example, the third reference point 350 may be located at a distance of 3 m from the second reference point 340. The fourth reference point 360 may be located at a distance of 3 m from the first reference point 330. The distance between the second reference point 340 and the third reference point 350 may be the same as the distance between the fourth reference point 360 and the first reference point 330.

The angle formed by the first to third reference points 330 and 350 may be 90 degrees. The angle formed by the second reference point 340 to the fourth reference point 360 may be 90 degrees. The angle formed by the first reference point 330, the third reference point 350, and the fourth reference point 360 may be 90 degrees.

The area setting unit 120 sets the area within the line connecting the reference points 330, 340, 350, and 360 as the warning area 210. The area setting unit 120 may set the area within the line connecting the first to fourth reference points 330 to 360 as the warning area 210.

The subject vehicle may perform braking control when a moving object 230 is present within the warning area 210. In addition, when the moving object 230 is present within the warning area 210, the subject vehicle may provide a warning to the driver using one or more of visual, auditory, and tactile means.

Although the foregoing description includes specific numerical values, the numerical values are only examples for description and the present disclosure is not necessarily limited to the aforementioned numerical values.

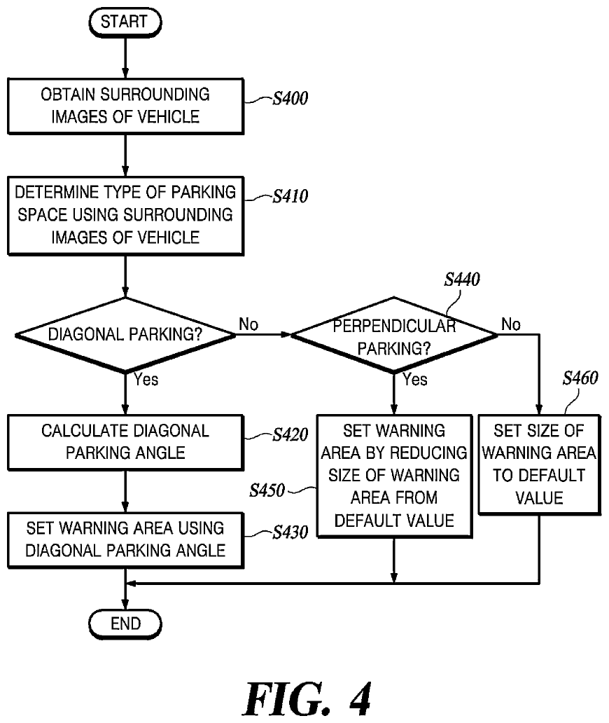

FIG. 4 is a flowchart showing a method for setting a warning area.

Referring to FIG. 4, the sensor unit 100 obtains surrounding images of the vehicle (S400). The surrounding images of the vehicle include images of the front, rear, left, and right sides of the vehicle. The sensor unit 100 transmits the obtained surrounding images of the vehicle to the determination unit 110.

The determination unit 110 receives the surrounding images of the vehicle from the sensor unit 100. The determination unit 110 determines the type of the parking space 220 using the surrounding images of the vehicle (S410). The type of the parking spaces 220 includes, for example, perpendicular parking and diagonal parking. The determination unit 110 may determine the type of the parking space 220 using a pre-trained artificial intelligence model to determine the type of the parking space 220.

When the type of the parking space 220 is diagonal parking, the determination unit 110 calculates a diagonal parking angle (S420). The diagonal parking angle indicates the angle between the diagonally parked vehicle and the direction of vehicle traffic. The determination unit 110 generates a virtual straight line connecting vertices of parking lines that do not contact other parking lines. The determination unit 110 calculates the diagonal parking angle between the virtual straight line and the center line of the vehicle.

The area setting unit 120 sets the warning area 210. When the type of the parking space 220 is diagonal parking, the area setting unit 120 sets the warning area 210 using the diagonal parking angle (S430). The area setting unit 120 sets a vehicle coordinate system, which is a virtual polar coordinate system, and sets the reference points 330, 340, 350, and 360 using the distance from the origin and the diagonal parking angle. The area setting unit 120 sets the area within the line connecting the reference points 330, 340, 350, and 360 as the warning area 210.

If the type of the parking space 220 is not diagonal parking, the determination unit 110 determines whether the type of the parking space 220 is perpendicular parking (S440).

If the type of the parking space 220 is perpendicular parking, the area setting unit 120 reduces the warning area 210 (S450). For example, the area setting unit 120 may reduce the warning area 210 from an area 6 m behind the subject vehicle to an area 3 m behind the subject vehicle.

If the type of the parking space 220 is not perpendicular parking, the area setting unit 120 maintains the existing warning area 210. That is, the size of the warning area 210 is set to a default value (S450). The warning area 210 may be an area within 6 m from the rear of the subject vehicle.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various example embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various example embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a compact disc ROM (CD-ROM), magnetic tape, a floppy disk, a memory card, a hard disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one example embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

The present disclosure provides a rear cross-traffic collision-avoidance assist apparatus comprising: a memory in which instructions are stored and at least one processor, wherein the at least one processor is configured to, by executing the instructions: obtain surrounding images of a vehicle, determine a type of a parking space using the surrounding images of the vehicle and set a warning area by changing at least one of a size and an angle of the warning area from a default value on the basis of the type of the parking space.

The present disclosure provides an operating method of a rear cross-traffic collision-avoidance assist apparatus, comprising: obtaining surrounding images of a vehicle, determining a type of a parking space using the surrounding images of the vehicle and setting a warning area by changing at least one of a size and an angle of the warning area from a default value on the basis of the type of the parking space.

The size and angle of a warning area may be optimized by ascertaining the type of parking space and calculating the angle.

Although example embodiments of the present disclosure have been described for illustrative purposes, those skilled in the art will appreciate that various modifications, additions, and substitutions are possible, without departing from the idea and scope of the present disclosure. Therefore, example embodiments of the present disclosure have been described for the sake of brevity and clarity. The scope of the technical idea of the present disclosure is not limited by the illustrations. Accordingly, one of ordinary skill would understand that the scope of the present disclosure is not to be limited by the above explicitly described example embodiments but by the claims and equivalents thereof.

What is claimed is:

1. An apparatus comprising:
at least one sensor;
memory storing instructions; and
at least one processor configured to, by executing the instructions, cause the apparatus to:
obtain, via the at least one sensor, one or more images of a parking area associated with a vehicle;
determine, based on the one or more images, a type of a parking space in the parking area;
adjust, within the parking area, an area of interest by adjusting, based on the type of the parking space, at least one of a size of the area of interest or an angle of the area of interest based on a default value; and
control, based on the adjusted area of interest, an operation of the vehicle.

2. The apparatus of claim 1, wherein the type of the parking space comprises at least one of a parking space for perpendicular parking or a parking space for diagonal parking.

3. The apparatus of claim 2, wherein the at least one processor is configured to cause the apparatus to adjust the area of interest by:
adjusting, based on the type of the parking space being a parking space for perpendicular parking, a longitudinal distance of the area of interest from the vehicle to be less than the default value.

4. The apparatus of claim 2, wherein the at least one processor is configured to cause the apparatus to adjust the area of interest by:
determining, based on the type of the parking space being a parking space for diagonal parking, a diagonal parking angle.

5. The apparatus of claim 4, wherein the at least one processor is configured to cause the apparatus to adjust the area of interest further by:
changing, based on the diagonal parking angle, at least one of the size of the area of interest or the angle of the area of interest.

6. The apparatus of claim 5, wherein the at least one processor is configured to cause the apparatus to adjust the area of interest further by:
determining a vehicle coordinate system having axes respectively corresponding to longitudinal and lateral directions of the vehicle;
determining, based on the diagonal parking angle, a plurality of reference points in the vehicle coordinate system; and
adjusting, based on a line connecting the plurality of reference points, the area of interest.

7. The apparatus of claim 1, wherein the at least one processor is configured to cause the apparatus to control the operation of the vehicle by:
determining whether an object is present within the area of interest.

8. The apparatus of claim 7, wherein the at least one processor is configured to cause the apparatus to control the operation of the vehicle by:
generating, based on the object being present within the area of interest, a warning message.

9. The apparatus of claim 2, wherein the at least one processor is configured to cause the apparatus to adjust the area of interest by:
determining, based on the type of the parking space not being a parking space for perpendicular parking or a parking space for diagonal parking, the area of interest using the default value.

10. A method performed by a vehicle, the method comprising:
obtaining, via at least one sensor, one or more images of a parking area associated with the vehicle;
determining, based on the one or more images, a type of a parking space in the parking area;
adjusting, within the parking area, an area of interest by adjusting, based on the type of the parking space, at least one of a size of the area of interest or an angle of the area of interest based on a default value; and
controlling, based on the adjusted area of interest, an operation of the vehicle.

11. The method of claim 10, wherein the type of the parking space comprises at least one of a parking space for perpendicular parking or a parking space for diagonal parking.

12. The method of claim 11, wherein the adjusting of the area of interest comprises:
adjusting, based on the type of the parking space being a parking space for perpendicular parking, a longitudinal distance of the area of interest from the vehicle to be less than the default value.

13. The method of claim 12, wherein the adjusting of the area of interest comprises:
determining, based on the type of the parking space being a parking space for diagonal parking, a diagonal parking angle.

14. The method of claim 13, wherein the adjusting of the area of interest comprises:
changing, based on the diagonal parking angle, at least one of the size of the area of interest or the angle of the area of interest.

15. The method of claim 14, wherein the adjusting of the area of interest comprises:
determining a vehicle coordinate system having axes respectively corresponding to longitudinal and lateral directions of the vehicle;
determining, based on the diagonal parking angle, a plurality of reference points in the vehicle coordinate system; and
adjusting, based on a line connecting the plurality of reference points, the area of interest.

16. The method of claim 10, wherein the controlling of the operation of the vehicle comprises:
determining whether an object is present within the area of interest.

17. The method claim 16, wherein the controlling of the operation of the vehicle comprises:
generating, based on the object being present within the area of interest, a warning message.

18. The method of claim 11, wherein the adjusting of the area of interest comprises:
determining, based on the type of the parking space not being a parking space for perpendicular parking or a parking space for diagonal parking, the area of interest according to the default value.
